(19) United States
(12) Patent Application Publication
(10) Pub. No.: US 2026/0347090 A1
(43) Pub. Date: Nov. 5, 2026

(54) Portion Capsule for Preparing a Beverage by Means of a Beverage Preparation Machine, Beverage Preparation System and Method for Producing a Portion Capsule

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 19/485,868

(22) PCT Filed: May 22, 2024
(86) PCT No.: PCT/EP2024/064109

§ 371 Date: Nov. 19, 2025

(30) Foreign Application Priority Data
May 23, 2023 (DE) 10 2023 204 804.3

(51) Int. Cl. B65D 85/804; A47J 31/40; A47J 31/44; B65D 65/46

(52) U.S. Cl. CPC B65D 85/8058; A47J 31/407; A47J 31/4492; B65D 65/466; B65D 85/8064

(57) ABSTRACT

A portion capsule for preparing a beverage with a beverage preparation machine, the portion capsule including a base element with a cavity for receiving a raw beverage material and a lid element closing the cavity, the base element has a base region, a capsule wall extending from the base region to an open end, and a flange extending around the open end, the portion capsule having a detectable identification code, the portion capsule has a separately formed carrier element, the carrier element includes the identification code, the carrier element being arranged on a side of the flange facing away from the base region.

### CROSS REFERENCE TO RELATED APPLICATIONS

This application is a US National Stage Entry of PCT/EP2024/064109 filed on May 22, 2024, which claims priority to DE 10 2023 204 804.3 filed on May 23, 2023, all of which are hereby incorporated by reference herein in their entireties for all purposes.

### FIELD

The present invention is based on a portion capsule for preparing a beverage with a beverage preparation machine, wherein the portion capsule comprises a base element with a cavity for receiving a raw beverage material and a lid element closing the cavity, wherein the base element comprises a base region, a capsule wall extending from the base region to an open end and a flange extending around the open end, wherein the portion capsule has a detectable identification code.

### BACKGROUND

Such portion capsules are known from the prior art. For example, publication WO 2016/186488 A1 discloses such a generic portion capsule. Such a portion capsule is intended to be inserted into a brewing chamber in which the portion capsule is perforated in order to introduce liquid, usually in the form of hot water, into the cavity under pressure. The interaction between the introduced water and the raw beverage material, for example roasted and ground coffee, produces a beverage which leaves the portion capsule through an outlet area and enters a container.

For each type of single-serving capsule, there is usually a suitable beverage preparation machine that is optimized for preparing beverages based on the appropriate single-serving capsules. To avoid malfunctions, it has proven useful to provide such portion capsules with identification codes that can be read automatically by the machine so that a check can be carried out before the brewing process begins to determine whether the inserted portion capsule is compatible with the machine. In addition, a suitable brewing program for the raw beverage material in the portion capsule can be started if necessary.

It is known from the publications EP 3023362 B1, WO2020/201487 A1, WO 2023/007 027 A1 and U.S. Pat. No. 10,800,600 B2 to print optical detectable features in the form of barcodes or binary codes on the flange of the capsule. An adapter for a portion capsule is also known from US 2020/231 371 A1, whereby an identification means is arranged on the adapter.

In the known portion capsules, the lid element is bonded, in particular sealed, to the flange during manufacture. However, this can lead to a structural impairment of the flange. This can either damage an identification code that has already been applied or make subsequent application of the identification code more difficult.

It is also known to manufacture portion capsules from recyclable, biodegradable and/or compostable materials for reasons of sustainability and resource conservation. However, this is challenging, as it is also necessary to ensure that the portion capsule is aroma-tight, i.e. in particular gas-tight, in order to be able to store the raw beverage materials it contains in a near-optimal condition for as long as possible and thus ensure optimal beverage quality over a longer period of time.

When disposing of a portion capsule, it is therefore often essential to recycle the lid element separately from the base element and also to remove the already used raw beverage material or its residues from the base element beforehand. However, this is made more difficult with the known portion capsules on the one hand by the fact that the lid element is firmly attached to the flange of the base element, for example sealed, and on the other hand by the fact that the known identification codes are attached to the flange, which requires a sufficiently stable flange for reliable application and reading of the identification code.

### SUMMARY

It is a task of the present invention to provide a portion capsule with a detectable identification code, which represents an improvement over the solutions known from the cited prior art. In particular, it should be possible to apply the identification code to the portion capsule easily and without errors during manufacture of the portion capsule. In addition, it is desirable to further develop the known portion capsules in such a way that the identification code can be read more reliably in the beverage preparation machine. Finally, it is a task of the present invention to provide a more sustainable portion capsule which, in particular, is easier to disassemble into its components and which, as a whole, is more environmentally friendly than the known portion capsules.

The task of the present invention is solved with a portion capsule according to claim 1.

Advantageous embodiments and further embodiments of the invention can be seen from the sub-claims and from the following description with reference to the drawings.

The advantages explained for this object of the present invention and the associated embodiments apply correspondingly to the other objects of the present invention and vice versa.

A portion capsule for preparing a beverage with a beverage preparation machine is proposed, wherein the portion capsule has a base element with a cavity for receiving a raw beverage material and a lid element closing the cavity, wherein the base element comprises a base region, a capsule wall extending from the base region to an open end and a flange running around the open end, wherein the portion capsule has an identification code which can be detected, in particular optically.

The portion capsule according to the invention is now provided in such a way that the portion capsule comprises a separately formed carrier element, the carrier element having the identification code, the carrier element being arranged on the side of the flange facing away from the base region. Thus, in particular, the information encoded by the identification code is stored in or on the carrier element.

The portion capsule according to the invention has the advantage over the portion capsules known from the prior art that the identification code is not provided on the flange, but on or in the additional carrier element which is separate from the base element. This eliminates a possible source of error during the manufacture and/or use of the capsule. In addition, the flange is now not required for applying the identification code, which provides space for additional functions. For example, the flange can now be used for sealing in the brewing chamber.

In the context of the present invention, an identification code should preferably be understood as any machine-readable information. In particular, this also includes information that can be interpreted by the beverage preparation machine as binary information in the sense of a “1” or “0” or a “yes” or “no”. The identification code is particularly preferably designed in such a way that the beverage preparation machine identifies the portion capsule, in particular the carrier element, as suitable for preparation in the beverage preparation machine in the event of successful detection. For example, at least one surface section of the carrier element, preferably a circumferential surface section, can have a predetermined electrical conductivity. The beverage preparation machine then preferably detects the electrical conductivity before the beverage preparation and releases a beverage preparation if the predetermined electrical conductivity is measured. Even more preferably, the identification code comprises further information, for example on preparation parameters and/or information on a raw beverage material contained in the portion capsule, which can then be detected and converted, in particular by the beverage preparation machine. The beverage preparation machine, in particular a control unit of the beverage preparation machine, can decode the information stored in the carrier element. Alternatively, it is also conceivable, for example, that different predetermined electrical conductivities can encode different information. For example, different discrete values of electrical conductivity can be assigned specific information, such as preparation parameters and/or information relating to the raw beverage material.

Preferably, the identification code is arranged on the carrier element. Preferably, the detectable identification code is printed on the carrier element or inserted into the carrier element, for example embossed. Alternatively or additionally, the identification code is provided in one piece with at least one part of the carrier element. Particularly preferably, the identification code comprises a barcode, in particular a bit and/or barcode, the coding bars of which run in particular in a radial direction. Very preferably, the coding bars comprise white and/or black bars of equal or unequal thickness along a circumferential direction (concentric around the central axis). Further examples of an identification code are an area with a predetermined optical reflectivity, an area with predetermined magnetic and/or electrical properties, an RFID code, in particular an RFID code detectable by means of near field communication (NFC) (i.e. an NFC code), a DataMatrix code, a Maxi code, an Aztec code, a JAB code and/or a QR code. Alternatively or additionally, information can also be encoded via a mechanical property of the carrier element. For example, a thickness (in the axial direction), a diameter (in the radial direction), a surface quality and/or an elasticity of the carrier element can be detected by the beverage preparation machine.

According to a preferred embodiment of the present invention, it is provided that the lid element is an elastic lid film and/or has a material reservoir, wherein the lid element is designed such that it bulges outwards, for example due to outgassing of the raw beverage material, i.e. assumes a convex shape. A material storage means in particular that in the fixed state the lid element is not under tension, but can bulge outwards in particular under the pressure of the gas produced in the cavity of the portion capsule, for example carbon dioxide in the case of roasted coffee as the raw beverage material. The skilled person understands that in this case the lid element is convex in cross-section after the cavity containing the raw beverage material has been sealed off, in particular in an airtight and/or aroma-tight manner. This makes it possible in a particularly advantageous way that any pressure arising in the cavity can be at least partially absorbed by a deformation of the lid element and does not act completely on the base element, which is particularly important in the case of a base element made of sustainable materials.

According to a preferred embodiment of the present invention, it is provided that the lid element is a substantially flexible lid film. Preferably, the lid element is provided in one or more layers. Particularly preferably, the lid element comprises at least one barrier layer and at least one carrier layer. Such a barrier layer is particularly impermeable to gases such as oxygen. Most preferably, the lid element comprises at least one layer of an aluminum material. The lid element preferably comprises a plastic-aluminum composite film or a plastic film or a multilayer plastic film. It is particularly preferred that the lid element is essentially made of one material over its entire length, or that the lid element is at least partially made of different materials in different areas. This makes it possible in an advantageous way for the portion capsule to be sealed in an aroma-tight manner by an appropriately selected lid film and for the raw beverage material to retain its aroma even over a longer storage period.

According to a preferred embodiment of the present invention, the portion capsule contains one or more raw beverage materials. The raw beverage material may be a liquid, a syrup, a solid, a powder, coffee or cocoa grounds and/or leaves, in particular coffee roast granules, instant coffee, chocolate powder, tea grounds and/or milk powder. The beverage raw material is preferably dilutable, dissolvable and/or extractable in a beverage preparation machine and/or a beverage preparation system to produce a beverage.

According to a preferred embodiment of the present invention, it is provided that the flange of the base element extends at an angle of between 70 to 110 degrees, particularly preferably of 80 to 100 degrees, and most preferably of substantially 90 degrees to the central axis. The flange is preferably of closed circumferential design, in particular with a constant radial extension.

According to a preferred embodiment of the present invention, it is provided that the support element is arranged on the side of the lid element facing away from the flange. This side can also be referred to as the upper side of the flange. This advantageously enables the carrier element to be connectable to the lid element, so that preferably the carrier element and the lid element form a unit which can be removed together from the base element, particularly preferably when the portion capsule is disposed of. Furthermore, in this way the flange can interact directly with an element of the beverage preparation machine, for example a brewing chamber part, and thus in particular achieve a sealing effect.

According to a preferred embodiment of the present invention, it is provided that the support element is arranged at least partially between the flange and the lid element. Alternatively, it is provided that the lid element is arranged at least partially between the flange and the support element. This advantageously enables the carrier element to be connected to the lid element, so that the carrier element and the lid element preferably form a unit.

According to a preferred embodiment of the present invention, it is provided that the carrier element is an insert which extends at least partially below the lid element radially in the direction of a central capsule axis, wherein the insert preferably fills the entire inner cross-section of the base element. Particularly preferably, the support element is spaced from the lid element at least in a central area, preferably over the entire free cross-section of the base element. Very preferably, the support element has holes or perforations and/or a filter material in at least one area. According to a preferred embodiment of the present invention, it is provided that the lid element is attached to the capsule wall, in particular to the inside of the capsule wall. The lid element can, for example, be guided slightly into the cavity via a sonotrode and connected there laterally to the capsule wall with a material bond or glued to the capsule wall. It is particularly preferable for the lid element to be connected to the capsule wall from the inside. This makes it possible in a particularly advantageous way to combine several functions in the carrier element. According to the invention, the main function of the carrier element is to serve as a carrier for the identification code. At the same time, however, a carrier element designed as an insert can also function as a filter element and/or liquid distributor and/or at least partially compress the raw beverage material. Another possible function of the carrier element is to simplify portion capsule recycling or disposal, which will be explained in more detail below.

Preferably, the lid element is arranged essentially flush with the flange and/or the carrier element. Particularly preferably, the main extension planes of the lid element, the carrier element and/or the flange are essentially identical. Essentially means that the main extension planes can be provided parallel to each other, but have a slight offset in a vertical direction, in particular along a central capsule axis. This advantageously makes the portion capsule more compact in the area of the flange.

According to a preferred embodiment of the present invention, it is provided that the base element, the support element and/or the lid element is made of a recyclable, biodegradable and/or compostable, in particular home-compostable, material, in particular aluminum and/or a material comprising vegetable fibers and/or at least one polymer. Alternatively or additionally, a biobased plastic and/or an oxo-degradable or oxo-biodegradable plastic can also be considered as a material. In this case, aluminum is to be understood as an aluminum alloy with a high proportion of recycled aluminum. Possible polymers include polylactic acids (PLA), polycaprolactone (PCL), polyhydroxyalkanoates (PHA) and/or thermoplastic starch (TPS). Conceivable plant-based materials include wood, hemp, flax, cotton, bamboo and/or cellulose-based materials. Preferably, the base element, the carrier element and/or the lid element are provided in one or more layers. Particularly preferably, the base element, the carrier element and/or the lid element comprise at least one barrier layer and/or at least one carrier layer. In a particularly advantageous manner, a portion capsule is thus provided which is at least partially recyclable and/or biodegradable. In this way, an environmentally friendly portion capsule is made possible. Preferably, the base element comprises a coating on the inside of the portion capsule, i.e. on the side facing the cavity.

According to a preferred embodiment of the present invention, the base element is produced by cold or hot forming, in particular deep drawing. The design of the base element with cavity is preferably produced by thermoforming, for example deep drawing by means of negative pressure, positive pressure and/or a movable punch. Alternatively, the portion capsule is produced by injection molding, in particular in a single-component, multi-component or in-mold process.

According to a preferred embodiment of the present invention, it is provided that the carrier element, the lid element and/or the base element comprise at least partially identical materials. This advantageously further simplifies disposal of the portion capsule.

According to a preferred embodiment of the present invention, it is provided that the carrier element has an internal diameter which is smaller than or equal to the internal diameter of the base element in the region of the flange. The inside diameter of the base element in the area of the flange is equivalent to the inside diameter of the base element in the area of the open end and is also referred to as the free inside diameter. An inside diameter of the support element smaller than the free inside diameter of the base element enables the support element to be attached to the lid element or to a region of the capsule wall adjacent to the flange, in addition to or as an alternative to attachment to the flange.

According to a preferred embodiment of the present invention, it is provided that the carrier element has an outer diameter which is larger than the outer diameter of the flange, so that the carrier element projects radially outwards beyond the flange, in particular uniformly along the circumference. In this way, it is advantageously ensured that the identification code is arranged outside the flange and can therefore be reliably read.

According to a preferred embodiment of the present invention, it is provided that the carrier element has an outer diameter which is greater than or equal to the outer diameter of the lid element. Especially if the lid element is arranged between the carrier element and the flange, this advantageously ensures that the identification code can be reliably read.

According to a preferred embodiment of the present invention, it is provided that the lid element protrudes beyond the flange. This is particularly advantageous if the carrier element is arranged between the lid element and the flange. In this case, a larger connecting surface between the support element and the lid element is made possible, which ensures a secure connection and thus increases the aroma tightness.

According to a preferred embodiment of the present invention, it is provided that the support element is semi-rigid or rigid. This ensures in a particularly advantageous manner that the identification code arranged on the carrier element can be reliably read. Particularly preferably, at least the area of the carrier element carrying the identification code is sufficiently rigid to ensure reliable detection of the identification code when inserted into a beverage preparation machine. Very preferably, the carrier element is at least partially elastic in order to enable the carrier element to be pulled off the base element.

According to the invention, it is provided that the carrier element is connected to the lid element and/or the flange in a detachable and material-locking manner, in particular by means of a peel connection. Particularly preferably, the lid element and/or the carrier element is bonded and/or sealed to the base element, in particular the flange. This makes it possible in a particularly advantageous manner that the carrier element and/or the lid element can be easily separated from the base element after use in order to simplify disposal of the portion capsule. A peel connection is to be understood in particular as a material-locking connection which ensures an aroma-tight closure of the portion capsule and also holds it during use in a beverage preparation machine, but which can be released by a user by exerting a tensile force. Very preferably, the peel connection is designed in such a way that a force of between 2N and 20N, even more preferably between 6N and 12N, is required to manually release the connection.

According to a preferred embodiment of the present invention, it is provided that the support element is connected both to the lid element and to the flange, wherein the connection between the support element and the lid element is at least in sections stronger than the connection between the support element and the flange. It is particularly preferred that the support element and the lid element are provided together as a unit that can be detached from the base element. In this way, the unit can be separated from the base element after use, for example pulled off, the remaining raw beverage material can be removed from the cavity and the components can each be sent for suitable recycling.

According to a preferred embodiment of the present invention, it is provided that the connection between the support element and the flange and/or the lid element is formed with different strengths along the circumference, the connection preferably having a weakening region in at least one circumferential section. In this way, it is advantageously possible to ensure a tight connection and still ensure that the individual components can be easily separated from each other for disposal.

According to a preferred embodiment of the present invention, it is provided that the base element, the support element and/or the lid element are rotationally symmetrical about a central capsule axis. This advantageously ensures easier use, since a user does not have to pay attention to correct orientation when inserting it into a beverage preparation machine. In particular, this also enables use in a centrifugation-based beverage preparation machine.

According to a preferred embodiment of the present invention, it is provided that the support element has at least one, in particular flexible, tab section. Alternatively or additionally, the lid element has at least one, in particular flexible, tab section, wherein preferably the at least one tab section of the lid element overlaps at least partially, in particular completely, with the at least one tab section of the carrier element. In this way, a particularly simple separation of the components from one another is ensured.

According to a preferred embodiment of the present invention, it is provided that the carrier element is a ring element, in particular a circular ring element. A ring element is particularly advantageous because it enables both the identification code to be attached in a simple manner and a connection to the, in particular circular, lid element and/or the, in particular circular ring-shaped, flange.

According to a preferred embodiment of the present invention, it is provided that the identification code is electrically, optically, magnetically and/or mechanically detectable. In this way, a corresponding detector can advantageously be provided in the beverage preparation machine for a specific identification code.

According to a preferred embodiment of the present invention, it is provided that the identification code is provided at least on a side of the carrier element facing the base region of the portion capsule. Preferably, the identification code is provided on a side of the carrier element facing the base region. This position is also referred to as the underside in the context of the present invention. This refers to an orientation of the portion capsule, which rests with the base area on a surface and the lid element is aligned in a horizontal plane. Of course, the portion capsule can, for example, rest flat with the lid element on the surface, in which case the designations apply accordingly. This position of the identification code advantageously enables detection in a beverage preparation machine in a known manner.

According to a preferred embodiment of the present invention, it is provided that the identification code is provided radially on the outside of the carrier element. Particularly preferably, the identification code is provided in a circular ring-shaped area with a predetermined radial extension. Very preferably, the carrier element is arranged relative to the flange and/or the lid element in such a way that there is no overlap between the identification code and the lid element and/or the flange on the side facing the floor area. The identification code can thus advantageously be read completely and reliably. In other words, the carrier element preferably protrudes so far beyond at least the flange that the identification code is arranged completely radially outside the base element.

According to a preferred embodiment of the present invention, it is provided that the identification code is provided at least in sections circumferentially on the carrier element, in particular along the entire circumference of the carrier element. Particularly preferably, the identification code is provided repeatedly along the circumference of the carrier element. Alternatively, the identification code is only provided in certain areas. Very preferably, the identification code is provided several times along the circumference in predetermined and, in particular, evenly spaced areas. In this way, correct automatic detection of the identification code is ensured regardless of the orientation of the portion capsule in the beverage preparation machine.

According to a preferred embodiment of the present invention, it is provided that the carrier element comprises a radially inner region which extends at least in sections along the inner side of the capsule wall facing the cavity and is preferably attached thereto. In this way, the connection between the carrier element and the base element can be advantageously improved.

According to a preferred embodiment of the present invention, it is provided that the base element is substantially frustoconical and/or dome-shaped, wherein in particular the inner diameter increases from the base region in the direction of the open end, in particular continuously. Alternatively or additionally, the base element is at least in sections frustoconical, conical, cylindrical, spherical, hemispherical, elliptical or partially elliptical. The base element is preferably rigid or semi-rigid.

According to a preferred embodiment of the present invention, it is provided that at least one sealing element is arranged on the side of the flange and/or of the carrier element facing the base region, which sealing element is designed to produce a sealing effect with respect to liquid together with a brewing chamber of the beverage preparation machine accommodating the portion capsule. It is particularly preferred that the sealing element is formed separately from the base element and/or the carrier element, is formed in one piece with the base element and/or the carrier element, or is formed in a materially bonded manner on the base element and/or the carrier element. The sealing element can, for example, be designed in the form of a projection or several annular projections and/or in the form of an elastically deformable material area. In this way, the tightness is advantageously improved when used in a beverage preparation machine, whereby the sealing element can extend over the entire radial extent of the flange, since the identification code is provided on or at the carrier element.

According to a preferred embodiment of the present invention, it is provided that the portion capsule comprises at least one filter element and/or at least one liquid distribution element, wherein the filter element and/or the liquid distribution element is arranged in the cavity, in particular in the bottom region of the portion capsule. Such filter elements are already known and are used in particular to filter water before it comes into contact with the raw beverage material and/or to filter larger solid particles of the raw beverage material from the beverage. Liquid distribution elements are also already known and are used in particular to distribute a liquid, in particular water, which usually flows into the portion capsule under high pressure in the form of a jet, over the entire surface of the bed of raw beverage material, in particular evenly, and thus avoid possible effects that negatively influence the beverage quality, such as channeling. It is particularly preferred that the filter element and/or the liquid distribution element is fixed to the base area and/or the capsule wall in a form-fit, force-fit and/or material-fit manner. This advantageously ensures a fixed position of the filter element and/or liquid distribution element in the portion capsule. For example, a filter element comprises a fiber material, in particular a non-woven material.

A further object of the present invention is a beverage preparation system comprising a beverage preparation machine and a portion capsule according to the invention, wherein the beverage preparation machine has a brewing chamber accommodating the portion capsule, wherein the beverage preparation machine has a detector for detecting the, in particular optically detectable, identification code, wherein the detector is arranged in particular in the brewing chamber.

The beverage preparation system according to the invention is particularly advantageous because the identification code of the portion capsule can be read by means of the detector, even if the identification code is not arranged on the flange. If the detector is arranged in the brewing chamber, it is advantageously possible to detect the identification code of a portion capsule arranged in the brewing chamber. The brewing chamber can be open, at least partially closed and/or completely closed.

The advantages explained with respect to this object of the present invention and the associated embodiments apply correspondingly to the other objects of the present invention and vice versa.

According to a preferred embodiment of the beverage preparation system according to the invention, it is provided that the brewing chamber comprises a first brewing chamber part and a second brewing chamber part which are movable relative to each other between an open position, in which a portion capsule can be inserted into the brewing chamber, and a closed position, in which beverage preparation can be carried out. It is conceivable that one brewing chamber part is stationary and the other brewing chamber part is movable, as well as that both brewing chamber parts move relative to each other. The movement preferably takes place along a linear and/or at least partially curved path of movement. Additionally or alternatively, a rotational movement component is also conceivable.

According to a preferred embodiment of the beverage preparation system according to the invention, it is provided that the first brewing chamber part has a first piercing means which can be moved, in particular between a retracted position and an extended position, wherein the first piercing means, in particular in the extended position, pierces the lid element of the portion capsule, wherein the first piercing means preferably comprises a hollow needle through which a pressurized liquid can be fed to the cavity of the portion capsule in the extended position.

According to a preferred embodiment of the beverage preparation system according to the invention, it is provided that the second brewing chamber part comprises a second piercing means, in particular movable between a retracted position and an extended position, wherein the second piercing means is designed such that it perforates the lid element in an area radially spaced from the central axis, in particular provided in the vicinity of the flange, or the base area to form at least one beverage outlet.

Preferably, the first and second piercing means are essentially independent of each other. Particularly preferably, the beverage preparation machine is designed such that the first piercing means first perforates the lid element of the portion capsule in a central piercing area, with the first piercing means remaining in the extended position for supplying the liquid, in particular during beverage preparation, wherein the second piercing means subsequently perforates the lid element in an outer, preferably substantially annular region, in particular in the vicinity of the flange, and is then moved back into the retracted position so that the beverage can emerge unhindered through the beverage outlet openings thus formed.

According to a preferred embodiment of the beverage preparation system according to the invention, it is provided that the lid element comprises a circumferential perforated and/or porous beverage outlet area arranged in particular in the vicinity of and radially inside the flange. This is particularly advantageous for beverage preparation machines based on centrifugation, as the beverage is expelled in the outer area. Additional piercing means are advantageously not required in this case.

According to a preferred embodiment of the beverage preparation system according to the invention, it is provided that the brewing chamber for beverage preparation is designed to rotate about a central capsule axis in order to guide the beverage out of the portion capsule by centrifugal forces. This makes it advantageously possible for the pressurized liquid introduced into the cavity to flow through the raw beverage material, forming the beverage, and for the beverage to flow back along the capsule wall in the direction of the lid element due to the centrifugal forces and emerge from beverage outlet openings.

According to a preferred embodiment of the beverage preparation system according to the invention, it is provided that the detector is designed for electrical, optical and/or magnetic detection of the identification code. Preferably, the detector is matched to the identification code of the portion capsule. This means, for example, that a barcode is detected by an optically operating detector, while an identification code based on magnetic properties is detected by a magnetically operating detector.

According to a preferred embodiment of the beverage preparation system according to the invention, it is provided that the detector is intended to detect the identification code of the portion capsule in an open position of the brewing chamber, in an at least partially open position of the brewing chamber and/or during a movement of the brewing chamber, in particular a relative movement of the first brewing chamber part and/or second brewing chamber part with respect to each other. This advantageously enables the portion capsule to be verified or identified at an early stage by means of the identification code, so that the beverage preparation machine is ready for beverage preparation when the closed position of the brewing chamber is reached (or can indicate to the user, for example, that the portion capsule is not suitable or authorized for use in the beverage preparation machine.

Preferably, the detector is provided in such a way that the optically detectable identification code is read out before, during and/or after the rotation of the brewing chamber and/or the portion capsule. In this way, a particularly flexible beverage preparation machine is provided in a particularly advantageous manner.

A further object of the present invention is a use of a portion capsule according to the invention for preparing a beverage with the aid of a beverage preparation machine, in particular in a beverage preparation system according to the invention.

The advantages explained with respect to this object of the present invention and the associated embodiments apply correspondingly to the other objects of the present invention and vice versa.

Still another object of the present invention is a method of manufacturing a portion capsule according to the invention, wherein in a first step a base element, a carrier element and a lid element are provided, wherein the base element comprises a base region, a capsule wall extending from the base region to an open end and a flange extending around the open end and forms a cavity for receiving a beverage raw material, wherein the carrier element has a detectable identification code, wherein in a second step the cavity is filled with the raw beverage material, wherein in a third step the carrier element is connected to the lid element and/or the carrier element is connected to the base element, in particular the flange, and/or the lid element is connected to the base element, in particular the flange, wherein the carrier element is arranged on the side of the flange facing away from the base region.

This makes it possible, in a particularly advantageous way, for the identification code to be detected in the beverage preparation machine, even though the identification code is not arranged on the base element and, in particular, the flange. In addition, separate disposal of the components is simplified, since, for example, the carrier element and the lid element can together form a unit which can be separated from the base element at the same time.

The advantages explained with respect to this object of the present invention and the associated embodiments apply correspondingly to the other objects of the present invention and vice versa.

According to the invention, it is provided that the carrier element and/or the lid element is connected to the base element, in particular the flange, by means of a detachable material connection, in particular a peel connection.

Further details, features and advantages of the portion capsule, the beverage preparation system, the use or the method can be seen from the drawings, as well as from the following description of preferred embodiments with reference to the drawings. The drawings merely illustrate exemplary embodiments of the portion capsule, which do not limit the essential idea of the invention.

### BRIEF DESCRIPTION OF THE DRAWINGS

FIG. 1 shows a schematic cross-section of a portion capsule according to an exemplary first embodiment of the present invention.

FIG. 2 shows a schematic cross-section of a portion capsule according to an exemplary second embodiment of the present invention.

FIG. 3 shows a schematic cross-section of a portion capsule according to an exemplary third embodiment of the present invention.

FIG. 4 shows a schematic cross-section of a portion capsule according to an exemplary fourth embodiment of the present invention.

FIG. 5 shows a schematic cross-section of a portion capsule according to an exemplary fifth embodiment of the present invention during disposal of the portion capsule.

FIG. 6 shows a schematic cross-section of a portion capsule according to an exemplary sixth embodiment of the present invention.

FIG. 7 shows a schematic cross-section of a portion capsule according to an exemplary seventh embodiment of the present invention.

### DETAILED DESCRIPTION

The embodiments explained below each show a portion capsule of essentially the same design. Identical parts are therefore designated with the same reference signs and are not described again in detail. Rather, the following explanations are primarily intended to highlight the differences between the embodiments.

FIG. 1 shows a schematic cross-section of a portion capsule 1 according to an exemplary first embodiment of the present invention. The portion capsule 1 is intended for use in a beverage preparation machine for preparing a beverage, in particular by passing a liquid through the portion capsule 1.

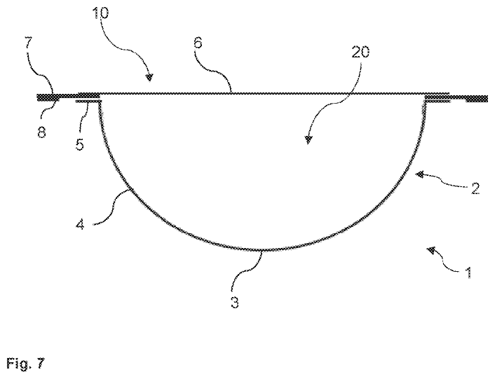

The portion capsule 1 has a base element 2. The base element 2 comprises a capsule wall 4, which is also referred to as the capsule side wall or side wall. The capsule wall 4 extends from a base area 3, which is also referred to as the capsule base, to a circumferential flange 5, which protrudes laterally and in particular is circumferential. Preferably, the flange 5 projects essentially at a 90° angle to a central capsule axis 100, also referred to as the central axis 100, which runs through the middle of the portion capsule 1. The base area 3 is provided horizontally here, so that an angle is formed in the transition to the capsule wall 4, but can alternatively also merge smoothly into the capsule wall 4 (see FIG. 7). According to the embodiment shown here, the base element 2 is essentially frustoconical in shape.

The base element 2 spans a cavity 20, which is intended to hold raw beverage material, for example roasted and ground coffee (for reasons of clarity, the raw beverage material is not illustrated in the figures). On the side facing away from the base area 3, the base element has an open end 10, which forms a filler opening during the production of the single-serving capsule 1, through which the cavity 20 can be filled with the raw beverage material.

The capsule wall 4 extends between the base area 3 and the flange 5. At the upper end of the capsule wall 4, the flange 5 extends in a radial direction, relative to the central axis 100, and is circular and thus circumferential in the circumferential direction.

The portion capsule 1 is usually sealed with a lid element 6, also referred to as a capsule lid, preferably in the form of a lid film 6, in particular a circular one, preferably hermetically, in particular aroma-and/or air-tight. The lid film 6 thus closes off the cavity 20 at the open end 10 of the base element 2.

An exemplary use of a portion capsule 1 according to the invention is briefly described below. The portion capsule 1 is intended to be inserted into a brewing unit of a beverage preparation machine in order to produce a beverage. The brewing unit comprises a first brewing chamber part and a second brewing chamber part, wherein the first and second brewing chamber parts are movable, in particular pivotable or displaceable, relative to each other between an approximate position in which the first and second brewing chamber parts form a closed brewing chamber and an open position in which the first and second brewing chamber parts are spaced apart from each other for insertion or ejection of the portion capsule 1. For the sake of completeness only, it is noted in this context that, despite the designation “brewing unit” and “brewing chamber”, beverage preparations are also included and meant which do not comprise brewing and/or extraction in the narrower sense. In particular, dissolving the raw beverage materials with hot and/or cold water is also covered.

To prepare the beverage, a portion capsule 1 is inserted into the brewing unit in the open position and the brewing unit is closed. A first piercing means is moved in a central area, preferably exactly in the middle, i.e. along the central axis 100, from a retracted position to an extended position. In doing so, the first piercing means pierces the lid film 6. For the sake of clarity, the beverage preparation machine and its components are not shown in the figures. For clarity, only a symbolic detector 30 is shown, which is arranged in such a way that the identification code 8 can be read.

The first piercing means preferably comprises a hollow needle and/or an injection needle through which a liquid, in particular heated and pressurized water, for example between 5 and 20 bar, is injected into the cavity. The liquid flows through the raw beverage material and interacts with it to form a beverage.

Preferably, the beverage preparation machine comprises a second piercing means, which particularly preferably comprises at least one piercing blade, in particular a plurality of piercing blades arranged in a ring shape, which are arranged in particular substantially along a circular ring in the vicinity of the flange 5, are moved from a retracted position to an extended position so that they locally cut through the lid film 6, forming beverage outlet openings, and are moved back to the retracted position so as not to block the beverage outlet openings.

The portion capsule 1 and/or the brewing unit is now rotated around the central capsule axis 100, preferably by a drive, for example an electric motor. In order to ensure rotation that is as trouble-free as possible and to save the user from having to pay attention to a predetermined orientation of the portion capsule during insertion, the portion capsule 1 and in particular the base element 2 is preferably designed to be rotationally symmetrical about the central axis 100. As a result, the liquid and/or the beverage is conveyed outwards towards the capsule wall 4 by centrifugal forces and then upwards along the capsule wall 4. The finished beverage then exits through the beverage outlet openings and can be directed there in the direction of a beverage outlet of the beverage preparation machine into a container, such as a cup.

Alternatively or in addition to the lid film 6, the base area 3 can be perforated in the closed position to create an opening for introducing liquid or for discharging the beverage. This is particularly the case with beverage preparation machines that are not based on centrifugation.

The portion capsule 1 according to the invention is not limited to the specific shape of the capsule body and/or the portion capsule 1 can also be used in other types of beverage preparation machines, for example those in which preparation is not based on centrifugation.

An optional filter medium can be used to filter any particles of the raw beverage material from the beverage and retain them in the portion capsule 1. Preferably, the lid film 6 acts as a filter element. Alternatively, the filter element is a separate element inserted into the portion capsule. Alternatively or additionally, the portion capsule can also comprise a liquid distribution element.

The portion capsule 1 now comprises an identification code 8 that can be detected, in particular optically, by a detector 30 of the beverage preparation machine. This identification code 8 is preferably used so that the portion capsule 1 can be identified in the beverage preparation machine and/or brewing parameters can be controlled. In this way, the beverage preparation machine can, for example, verify whether the portion capsule 1 inserted into the brewing chamber is a compatible portion capsule 1 and/or a suitable brewing program for the raw beverage material in the portion capsule 1 can be automatically selected and, if necessary, started. It is also conceivable that brewing parameters to be used, such as the water temperature, the amount of water, the water pressure and/or the rotational speed of the portion capsule 1 during brewing, are embedded in the identification code 8 and are read out by means of the detector 30.

The identification code 8 is in particular a machine-readable code in the form of a one-dimensional or multi-dimensional bit or bar code 8. The bit or bar code 8 is completely or partially circumferentially formed as a circle or partial circle around the central axis A of the portion capsule 1. The individual adjacent bars that make up the bitcode or barcode 8, in particular the two-or multi-colored bitcode or barcode 8, then preferably extend in a radial direction and are arranged next to each other in the circumferential direction.

In the portion capsules 1 known from the prior art, this identification code 8 is usually provided on the underside, i.e. on the side of the flange 5 facing away from the lid film 6 and/or on the side of the flange 5 facing the base area 3. The identification code 8 can be provided in only one circumferential section, it can be provided in several circumferential sections that are preferably evenly spaced apart from one another, or it can be provided completely circumferentially. The identification code 8 is preferably printed, embossed or generated in some other way that enables (optical) detection by a detector 30 of the beverage preparation machine.

A common manufacturing process for a generic portion capsule provides, for example, that an identification code 8 is printed on the underside of the flange and the lid film 6 is sealed to the flange 5 before or after this. Sealing can directly destroy or damage the identification code 8 and/or the flange 5 is affected in such a way, for example by mechanical action, heat, pressure and/or radiation, that the structural properties, for example the surface roughness, of the flange 5 are adversely affected. This jeopardizes error-free detection of the identification code 8. In addition, such a manufacturing process makes environmentally friendly disposal of the portion capsule 1 more difficult and the flange 5 cannot fulfill any additional functions, such as sealing.

It is therefore desirable not to provide the identification code 8 on the flange 5.

According to the invention, it is therefore provided that the identification code 8 is not provided on the flange 5, and thus not on the base element 2, but on a separate carrier element 7. According to the embodiment shown here, this is essentially circular in shape, with an inner diameter corresponding to the inner diameter of the base element 2 at its open end 10, and with an outer diameter that is larger than the outer diameter of the lid element 6 and the flange 5.

According to the embodiment shown in FIG. 1, the lid element 6 is arranged between the support element 7 and the flange 5. Preferably, the lid element 6 is arranged on the flange 5 with a detachable connection, for example a peel connection, and/or the lid element 6 is connected to the support element 7 with a material bond, preferably with a detachable connection, in particular a peel connection. Particularly preferably, the connection between the carrier element 7 and the lid element 6 is tighter than the connection between the lid element 6 and the flange 5. In this way, it is possible for the user, after using the portion capsule 1, to grasp the carrier element 7 protruding from the outside of the flange 5 and detach it together with the lid element 6 from the base element 2. Alternatively, the carrier element 7 can then be separated from the lid element 6. Residues of the raw beverage material, for example moist coffee powder, can be removed manually from the cavity 20 and the components of the portion capsule 1 can be disposed of separately.

This is particularly advantageous if the base element 2, the lid element 6 and/or the carrier element 7 are made of recyclable, biodegradable and/or compostable materials.

The carrier element 7 has sufficient inherent rigidity so that the area with the identification code 8, which in particular protrudes completely above the flange 5 and can therefore be easily read by the detector 30, has an essentially horizontal extension.

In the present case, the lid element 6 has essentially the same outer diameter as the flange 5. This enables a maximum connection surface between the lid element 6 and the flange 5.

The identification code 8 is preferably provided on the underside of the carrier element 7, i.e. in particular on the side facing the floor area 3. The identification code 8 is, for example, printed on or embossed into the carrier element 7. The identification code 8 is thus preferably provided in the shape of a circular ring or at least a section of a circular ring, whereby the radial extent of the identification code 8 is smaller than the radial extent of the carrier element 7. The identification code 8 is particularly preferably provided at the radially outer end of the carrier element 7. The illustration in FIG. 1 is merely schematic and distances are shown larger than in reality for clarification. For example, the identification code 8 preferably does not protrude vertically from the carrier element 7 and the distance between the identification code 8 and the flange 5 is at least smaller or non-existent. The outer diameter of the carrier element 7 is also shown to be larger relative to the outer diameter of the flange 5, particularly in the drawing, than is intended in reality.

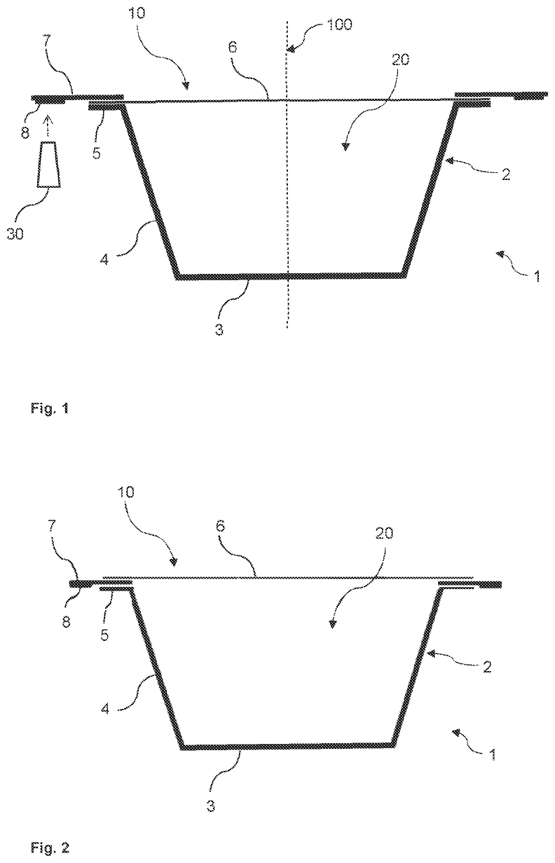

FIG. 2 shows a schematic cross-section of a portion capsule 1 according to an exemplary second embodiment of the present invention. The second embodiment essentially corresponds to the first embodiment explained in connection with FIG. 1, which is why reference is generally made to the relevant explanations. In contrast to the first embodiment, however, the support element 7 is provided here between the lid element 6 and the flange 5. This makes it easier to separate the support element 7 together with the lid element 6 connected to it from the base element 2. As shown here, the lid element 6 can still have essentially the same outer diameter as the flange 5, but the outer diameter of the lid element 6 can alternatively also have any value greater than the inner diameter and smaller than the outer diameter of the support element 7. This allows the strength of the connection between the support element 7 and the lid element 6 to be adjusted.

During disposal, the support element 7 and the lid element 6 form a unit, in particular a detachable unit, which is removed together from the base element 2.

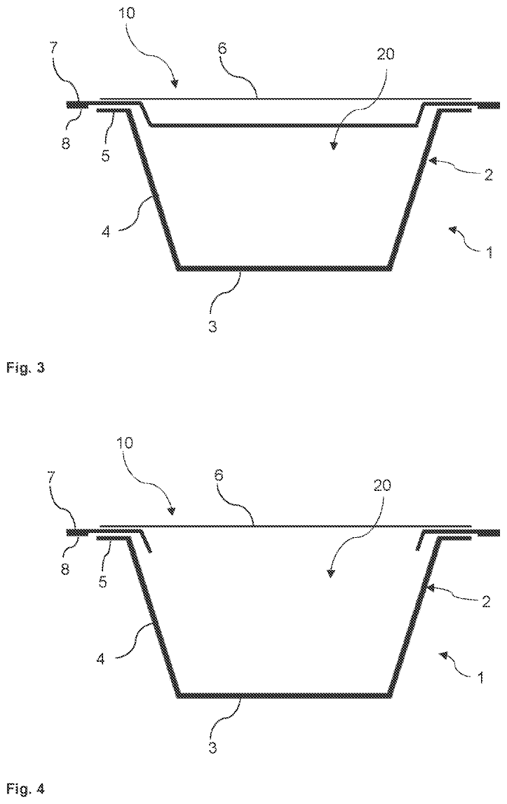

FIG. 3 shows a schematic cross-section of a portion capsule 1 according to an exemplary third embodiment of the present invention. This third embodiment essentially corresponds to the first and second embodiments explained in connection with FIGS. 1 and 2, which is why reference is generally made to the relevant explanations at. In contrast to the first and second embodiments, here the carrier element 7 is additionally designed as an insert, i.e. the carrier element extends transversely over the inner diameter of the base element 2, the carrier element 7 preferably being vertically spaced from the lid element 6 at least in a region of the open end 10 of the base element 2, as shown here. Here, the support element 7 comprises, among other things, regions which extend approximately parallel to the capsule wall 4 in sections and can preferably be attached thereto.

Preferably, the carrier element 7 comprises a filter material and/or liquid passage openings in at least one central and/or external area. The carrier element 7 is particularly preferably designed as a single piece or in several pieces. This makes it advantageously possible for the carrier element 7 to fulfill additional functions and, for example, act as a filter and/or liquid distributor. The carrier element 7 is therefore a multifunctional element.

FIG. 4 shows a schematic cross-section of a portion capsule 1 according to an exemplary fourth embodiment of the present invention. This fourth embodiment essentially corresponds to the first to third embodiments explained in connection with FIGS. 1-3, which is why reference is generally made to the relevant explanations. The embodiment shown here is particularly similar to the second embodiment, although here the carrier element 7 has a smaller internal diameter than the flange 5, as a result of which a circular ring-shaped region of the carrier element 7 protrudes inwards into the cavity 20. This area can be shaped or deformed during the manufacture of the portion capsule 1 in such a way that it runs essentially parallel to the capsule wall 4, at least in sections. In particular, the carrier element 7 can be attached to the capsule wall 4 in this area, in particular via a material-locking but detachable connection. This connection can be provided in addition to or as an alternative to a connection with the flange 5. Particularly if a detachable connection, such as a detachable adhesive connection and/or a peel connection, is provided to enable good disposal of the components of the portion capsule 1, it may be advantageous to provide a further connection area in addition to the overlap area between the flange 5 and the carrier element 7 in order to nevertheless ensure a reliable and aroma-tight closure of the portion capsule 1.

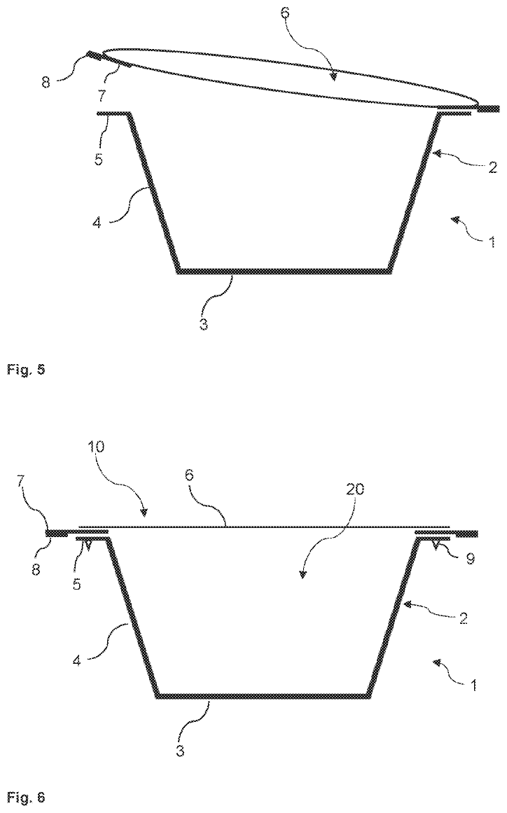

FIG. 5 shows a schematic cross-section of a portion capsule 1 according to an exemplary fifth embodiment of the present invention during disposal of the portion capsule 1. This fifth embodiment essentially corresponds to the first to fourth embodiments explained in connection with FIGS. 1-4, which is why reference is generally made to the relevant explanations. The embodiment shown here is particularly similar to the second embodiment, whereby it is shown schematically in the left-hand area how the carrier element 7 together with the lid element 6 attached thereto has been detached from the base element 2, in particular the flange 5, after the portion capsule 1 has been used in a beverage preparation machine. To do this, the user can grasp a protruding part of the carrier element 7 and pull it upwards from the flange 5. The remaining raw beverage material can then be removed from the cavity 20 and, for example, sent for composting and, optionally, the lid element 6 or the lid film 6 can be separated from the carrier element 7 so that these components can also be disposed of separately. This is particularly advantageous if the lid element 6 has an aluminum layer, while the carrier element 7 is made of a biodegradable and/or (home) compostable material.

In this way, the carrier element 7 increases the environmental friendliness of the portion capsule 1. Since the carrier element 7 protrudes beyond the flange 5 so that the identification code 8 can be detected, no separate tab needs to be provided. Optionally, the carrier element 7 and/or the lid element 6 has at least one such tab to simplify separation.

FIG. 6 shows a schematic cross-section of a portion capsule 1 according to an exemplary sixth embodiment of the present invention. This sixth embodiment essentially corresponds to the first to fifth embodiments explained in connection with FIGS. 1-5, which is why reference is generally made to the relevant explanations. In particular, the embodiment shown here can be combined with the previously explained embodiments. Here, the flange 5 comprises a sealing element 9, which is exemplified here as a circumferential, annular projection, in particular with an essentially triangular radial cross-section. However, this is to be understood as representative of a large number of one-piece or separately designed sealing elements 9. For example, the sealing element can be an annular sealing element 9, for example made of a cellulose-containing and/or swellable material in contact with liquid, which is fixed to the flange 5, or it can be a plurality of sealing projections, or an elastically deformable material, which is applied to the flange 5, in particular in a material-locking manner. The skilled person understands that the type, shape, size and position of such sealing elements 9 depend on the part of the beverage preparation machine that interacts with the flange 5 in a sealing manner, in particular the associated brewing chamber part.

FIG. 7 shows a schematic cross-section of a portion capsule 1 according to an exemplary seventh embodiment of the present invention. This seventh embodiment essentially corresponds to the first to sixth embodiments explained in connection with FIGS. 1-6, which is why reference is generally made to the relevant explanations. In contrast to these embodiments, the base element 2 is hemispherical here, so that the base area 3 merges smoothly into the capsule wall 4. Such a shape is particularly advantageous for use in beverage preparation machines based on centrifugation.

### LIST OF REFERENCE SYMBOLS

1 Portion capsule
2 Base element
3 Base area
4 Capsule wall
5 Flange
6 Lid element, lid foil
7 Support element
8 Identification code, barcode
9 Sealing element
10 Open end
20 cavity
30 detector
100 Central axis, capsule axis

1. A portion capsule for preparing a beverage with a beverage preparation machine, the portion capsule comprising a base element with a cavity for receiving a raw beverage material and a lid element closing the cavity, wherein the base element comprises a base region, a capsule wall extending from the base region to an open end, and a flange extending around the open end, the portion capsule having a detectable identification code, wherein the portion capsule comprises a separately formed carrier element, the carrier element comprises the identification code, the carrier element being arranged on a side of the flange facing away from the base region.

2. The portion capsule according to claim 1, wherein the carrier element is arranged on a side of the lid element facing away from the flange.

3. The portion capsule according to claim 1, wherein the carrier element is arranged at least partially between the flange and the lid element.

4. The portion capsule according to claim 1, wherein the carrier element is an insert which extends at least partially below the lid element radially in a direction of a central capsule axis, the insert filling an entire inner cross-section of the base element.

5. The portion capsule according to claim 1, wherein the base element, the carrier element, and/or the lid element comprises a recyclable, biodegradable, and/or compostable or home-compostable material, or aluminum and/or a material comprising vegetable fibers and/or at least one polymer.

6. The portion capsule according to claim 1, wherein the carrier element has an inside diameter which is smaller than or equal to an inside diameter of the base element in a region of the flange.

7. The portion capsule according to claim 1, wherein that the carrier element has an outer diameter which is larger than an outer diameter of the flange so that the carrier element projects radially outwards beyond the flange or uniformly along a circumference.

8. The portion capsule according to claim 1, wherein the carrier element has an outer diameter which is greater than or equal to an outer diameter of the lid element.

9. The portion capsule according to claim 1, wherein the carrier element is semi-rigid or rigid.

10. The portion capsule according to claim 1, wherein the carrier element is connected to the lid element and/or the flange in a detachable, or materially bonded manner or by means of a peel connection.

11. The portion capsule according to claim 1, wherein the carrier element is connected both to the lid element and to the flange, and a connection between the carrier element and the lid element is stronger, at least in sections, than a connection between the carrier element and the flange.

12. The portion capsule according to claim 1, wherein a connection between the carrier element and the flange and/or the lid element is of different strength along a circumference, the connection having a weakening region in at least one circumferential section.

13. The portion capsule according to claim 1, wherein the base region, the carrier element, and/or the lid element is rotationally symmetrical about a central capsule axis.

14. The portion capsule according to claim 1, wherein the carrier element has at least one flexible tab section.

15. The portion capsule according to claim 1, wherein the carrier element is a circular ring-shaped, ring element.

16. The portion capsule according to claim 1, wherein the identification code is electrically, optically, magnetically, and/or mechanically detectable.

17. The portion capsule according to claim 1, wherein the identification code is provided at least on one side of the carrier element facing the base region of the portion capsule.

18. The portion capsule according to claim 1, wherein the identification code is provided radially on an outside of the carrier element.

19. The portion capsule according to claim 1, wherein the identification code is provided on the carrier element circumferentially at least in sections, or along an entire circumference of the carrier element.

20. The portion capsule according to claim 1, wherein the carrier element comprises a radially inner region which extends at least in sections along an inner side of the capsule wall facing the cavity and is attached thereto.

21. The portion capsule according to claim 1, wherein the base element is essentially frustoconical and/or dome-shaped, or comprises an inner diameter increasing from the base region in a direction of the open end.

22. The portion capsule according to claim 1, wherein at least one sealing element is arranged on a side of the flange facing the base region and/or of the carrier element, the sealing element is configured to produce a sealing effect with respect to liquid together with a brewing chamber of the beverage preparation machine accommodating the portion capsule.

23. The portion capsule according to claim 22, wherein the sealing element is formed separately from the base element and/or the carrier element, is formed in one piece with the base element and/or the carrier element, or is formed on the base element and/or the carrier element in a materially bonded manner.

24. The portion capsule according claim 1, wherein the portion capsule comprises at least one filter element and/or at least one liquid distributor element, the at least one filter element and/or the at least one liquid distributor element being arranged in the cavity or in the base region of the portion capsule.

25. The portion capsule according to claim 24, wherein the at least one filter element and/or the at least one liquid distributor element is fixed to the base region and/or the capsule wall in a form-fitting, force-fitting. and/or material-fitting manner.

26. A beverage preparation system comprising a beverage preparation machine and the portion capsule according to claim 1, wherein the beverage preparation machine has a brewing chamber accommodating the portion capsule, wherein the beverage preparation machine has a detector for detecting the detectable identification code, wherein the detector is arranged particular in the brewing chamber.

27. The beverage preparation system according to claim 26, wherein the brewing chamber has a first brewing chamber part and a second brewing chamber part, which are movable relative to one another between an open position, in which the portion capsule can be introduced into the brewing chamber, and a closed position, in which beverage preparation can be carried out.

28. The beverage preparation system according to claim 27, wherein the first brewing chamber part has a first piercing means, or is movable between a retracted position and an extended position, wherein the first piercing means, in the extended position, pierces the lid element of the portion capsule, wherein the first piercing means preferably-comprises a hollow needle through which, in the extended position, a pressurized liquid can be fed to the cavity of the portion capsule.

29. The beverage preparation system according to claim 28, wherein the second brewing chamber part comprises a second piercing means, that is movable between a retracted position and an extended position, wherein the second piercing means is designed such that it perforates the lid element in a region radially spaced from the central axis, provided in a vicinity of the flange, or the bottom region, to form at least one beverage outlet.

30. The beverage preparation system according to claim 26, wherein the lid element comprises a circumferential perforated and/or porous beverage outlet region arranged in a vicinity of and radially inside the flange.

31. The beverage preparation system according to claim 26, wherein the brewing chamber for the beverage preparation is designed to be rotatable about a central capsule axis in order to guide the beverage out of the portion capsule by centrifugal forces.

32. The beverage preparation system according to claim 26, wherein the detector is designed for electrical, optical, and/or magnetic detection of the identification code.

33. The beverage preparation system according to claim 26, wherein the detector is provided for detecting the identification code of the portion capsule in an open position of the brewing chamber, in an at least partially open position of the brewing chamber, and/or during a movement of the brewing chamber, or a relative movement of the first brewing chamber part and/or the second brewing chamber part with respect to each other.

34. Use of the portion capsule according to claim 1, for preparing the beverage by means of the beverage preparation machine.

35. A method for producing the portion capsule according to claim 1, wherein in a first step, the base element, the carrier element, and the lid element are provided, wherein the base element comprises the base region, the capsule wall extending from the base region to the open end, and the flange running around the open end and forming the cavity for receiving the raw beverage material, the carrier element having the detectable identification code, wherein in a second step, the cavity is filled with the raw beverage material, wherein in a third step, the carrier element is connected to the lid element and/or the carrier element is connected to the base element or the flange, and/or the lid element is connected to the base element or the flange, the carrier element being arranged on the side of the flange facing away from the base region.

36. The method according to claim 35, wherein the carrier element and/or the lid element is connected to the base element or to the flange, by means of a detachable connection or a detachable material-locking connection, or a peel connection.
